(19) United States
(12) Patent Application Publication
(10) Pub. No.: US 2024/0369437 A1
(43) Pub. Date: Nov. 7, 2024

(54) Locking Device Having Applied Thereto Colorimetric Sensor for Detecting Hazardous Chemical Leak

(71) Applicant: IDKLAB INC., Daejeon (KR)

(72) Inventors: Wong Tae Hwang, Daejeon (KR); Sung-Ho Shin, Daejeon (KR); Hwan Soo Kim, Daejeon (KR); Jina Kim, Daejeon (KR)

(21) Appl. No.: 18/775,503

(22) Filed: Jul. 17, 2024

Related U.S. Application Data
(63) Continuation of application No. PCT/KR2023/002042, filed on Feb. 13, 2023.

(30) Foreign Application Priority Data
Feb. 14, 2022 (KR) 10-2022-0018877

(51) Int. Cl. G01M 3/04; F16L 55/07

(52) U.S. Cl. CPC G01M 3/04; F16L 55/07

(57) ABSTRACT

Disclosed is a locking device having applied thereto a colorimetric sensor for detecting hazardous chemical leak. The locking device for a fitting, according to an embodiment, may include: a fitting locking portion made of a transparent material and provided to surround a fitting of a pipe or valve; and a colorimetric sensor which is disposed inside the fitting locking portion and which changes in color due to a hazardous chemical leaked from the fitting.

### CROSS-REFERENCE TO RELATED APPLICATION(S)

This application is bypass continuation of International Application No. PCT/KR2023/002042, filed Feb. 13, 2023, which claims the benefits of Korean Patent Application No. 10-2022-0018877, filed on Feb. 14, 2022, in the Korean Intellectual Property Office, the disclosures of which are herein incorporated by reference in their entireties.

### BACKGROUND

### Field

The following description relates to a locking device to which a colorimetric sensor capable of observing and detecting leakage of hazardous chemicals in a pipe connecting portion is applied.

### Description of Related Art

Pulsation and micro-vibration occurring inside a pipe may cause a pipe coupling portion, which is a pipe connecting portion, to become loose or may cause micro distortion of the pipe coupling portion. In this case, leakage of hazardous chemicals may occur. Also, toxic gas or chemicals may gradually corrode and harden sealing of the pipe coupling portion and an internal O-ring of a clamp, which may lead to generating a crack and leaking hazardous chemicals. In the event of an accident due to the leakage of hazardous chemicals, enormous property damage, casualties, and loss of corporate reputation may arise.

### SUMMARY

Example embodiments provide a locking device that may prevent leakage of hazardous chemicals due to a loose connection portion (fitting) of a pipe or a valve and, at the same time, may quickly detect a leakage area.

According to an example embodiment, there is provided a locking device for fitting, including a fitting locking portion made of a transparent material and provided to surround a fitting of a pipe or a valve; and a colorimetric sensor provided inside the fitting locking portion and of which color changes due to hazardous chemicals leaked from the fitting.

According to an aspect, the colorimetric sensor may include a nanofiber membrane in a three-dimensional (3D) porous structure, bound with color dye of which color changes due to hazardous chemicals.

According to another aspect, the color dye may be mixed in a polymer solution and electrospun and bound to the nanofiber membrane that is manufactured through the electrospinning or bound on the nanofiber membrane through solution coating or chemical vapor deposition.

According to still another aspect, the colorimetric sensor may be attached to a transparent double-sided adhesive tape capable of supporting a nanofiber membrane included in the colorimetric sensor and fixedly attached inside the fitting locking portion through the transparent double-sided adhesive tape.

According to still another aspect, the fitting locking portion may include a fitting support member configured to surround a portion of the fitting of the pipe; a fitting cover member configured to surround a remainder of the fitting to correspond to the fitting support member; a connecting portion configured to rotatably connect one end of the fitting support member and one end of the fitting cover member; and a locking portion configured to secure another end of the fitting support member and another end of the fitting cover member to enable opening and closing.

According to still another aspect, the fitting locking portion may include a first fitting locking portion configured to surround a first fitting that connects the valve and a first pipe; a second fitting locking portion configured to surround a second fitting that connects the valve and a second pipe; and a locking portion connecting portion configured to connect the first fitting locking portion and the second fitting locking portion.

According to still another aspect, each of the first fitting locking portion and the second fitting locking portion may include a fitting support member configured to surround a portion of a corresponding fitting; a fitting cover member configured to surround a remainder of the fitting to correspond to the fitting support member; a connecting portion configured to rotatably connect one end of the fitting support member and one end of the fitting cover member; and a locking portion configured to secure another end of the fitting support member and another end of the fitting cover member to enable opening and closing.

According to still another aspect, the colorimetric sensor may be provided each inside the locking portion included in the first fitting locking portion and inside the locking portion included in the second fitting locking portion.

According to still another aspect, the colorimetric sensor may be provided inside the locking portion.

According to still another aspect, an uneven portion configured to engage each of a plurality of edges formed in a corresponding fitting may be formed inside at least one of the fitting support member and the fitting cover member.

According to an example embodiment, there is provided a method of manufacturing a colorimetric sensor for a locking device, the method including manufacturing a nanofiber membrane in a three-dimensional (3D) porous structure, bound with color dye of which color changes due to hazardous chemicals; laminating one side of a transparent double-sided adhesive tape to one side of the manufactured nanofiber membrane; cutting the nanofiber membrane laminated with the transparent double-sided adhesive tape based on a preset side; and attaching the nanofiber membrane inside the locking device through another side of the transparent double-sided adhesive tape.

### BRIEF DESCRIPTION OF DRAWINGS

FIGS. 1 to 4 illustrate examples of a locking device for fitting according to an example embodiment.

FIGS. 5 to 7 illustrate examples of a locking device for fitting according to another example embodiment.

FIG. 8 is a flowchart illustrating an example of a method of manufacturing a colorimetric sensor for a locking device according to an example embodiment.

FIG. 9 is an image showing an example of nanofiber to which color dye is bound according to an example embodiment.

FIG. 10 is an image showing an example in which a nanofiber membrane to which color dye is bound is cut based on a preset size and laminated with a double-sized adhesive tape according to an example embodiment.

FIG. 11 illustrates results of hydrofluoric acid vapor exposure experiment of a litmus paper colorimetric sensor and a nanofiber-based colorimetric sensor according to an example embodiment.

### DETAILED DESCRIPTION

Hereinafter, example embodiments are described in detail with reference to the accompanying drawings. However, since various modifications may be made to the example embodiments, the scope of the claims is not limited or restricted by the example embodiments. It should be understood that all changes, equivalents, and substitutes for the example embodiments are included in the claims.

The terms used herein are for the purpose of describing the example embodiments only and are not to be limiting of the example embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, components, parts, or a combination thereof, but do not preclude the presence or addition of one or more other features, integers, steps, operations, components, parts, or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Also, when describing the example embodiments with reference to the accompanying drawings, like reference numerals refer to like components and a repeated description related thereto will be omitted. When it is determined that detailed description related to the known art may make the gist of the example embodiments unnecessarily obscure in describing the example embodiments, the detailed description is omitted.

In addition, terms such as first, second, A, B, (a), (b), and the like may be used herein to describe components. Each of these terms is not used to define an essence, order, or sequence of a corresponding component but used merely to distinguish the corresponding component from other component(s). When it is mentioned that one component is “connected,” “coupled,” or “accessed” to another component, it may be understood that the one component is directly connected or accessed to another component and it should be understood that still another component is “connected,” “coupled,” or “accessed” between the respective components.

A component included in one example embodiment and a component including a common function are described using the same name in other example embodiments. Unless stated otherwise, description related to one example embodiment may be applied to other example embodiments and further description within the repeated extent is omitted.

The example embodiments relate to a locking device made of a transparent material, including a colorimetric sensor and, in an example embodiment, relate to a locking device for fitting that may prevent a fitting of a pipe or a valve from loosening due to external force or internal pressure of a pipeline by protecting the outside of the fitting, and may quickly detect a leakage status by including a colorimetric sensor capable of detecting water leakage or leakage from the fitting.

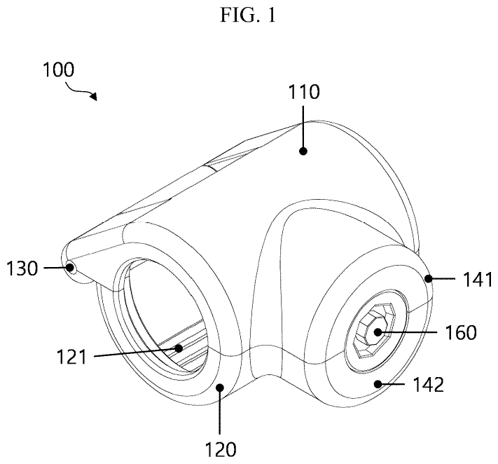

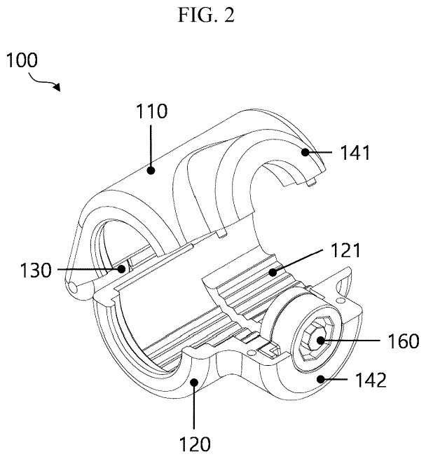

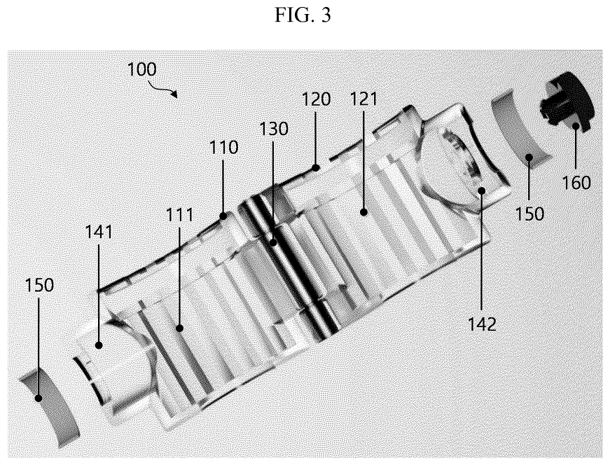

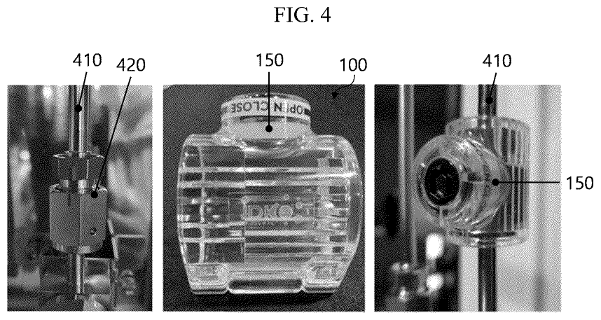

FIGS. 1 to 4 illustrate examples of a locking device for fitting according to an example embodiment. The locking device for fitting according to the example embodiment may include a fitting locking portion 100 made of a transparent material and provided to surround a fitting 420 of a pipe 410 and a colorimetric sensor 150 provided inside the fitting locking portion 100 and of which color changes due to hazardous chemicals leaked from the fitting 420. Here, FIGS. 1 and 2 illustrate a structure of the fitting locking portion 100, FIG. 3 illustrates the fitting locking portion 100 and the colorimetric sensor 150, and FIG. 4 illustrates an example of an image of the locking device for fitting actually implemented by attaching the colorimetric sensor 150 inside the fitting locking portion 100 and an image in which the locking device for fitting is coupled to surround the fitting 420.

Referring to FIGS. 1 to 3, the fitting locking portion 100 may include a fitting support member 120 configured to surround a portion of the fitting 420 and a fitting cover member 110 configured to surround a remainder of the fitting 420 to correspond to the fitting support member 120. Here, the fitting locking portion 100 may further include a connecting portion 130 configured to rotatably connect one end of the fitting support member 120 and one end of the fitting cover member 110. Here, the connecting portion 130 may be implemented in a hinge structure. The fitting locking portion 100 may further include locking portions 141, 142, and 160 configured to ensure another end of the fitting support member 120 and another end of the fitting cover member 110 to enable opening and closing. The locking portions 141, 142, and 160 are implemented to release the fitting locking portion 100 through a dedicated key. Therefore, any structure capable of serving to prevent arbitrary releasing of the fitting locking portion 100 may be used without being particularly limited. By providing the locking portions 141, 142, and 160 configured to be capable of opening and closing the fitting locking portion 100 through the dedicated key, it may be impossible for a person aside from an approved worker to open and close the fitting locking portion 100.

Here, as shown in FIGS. 3 and 4, the fitting locking portion 100 may be implemented using a transparent material such that a change in color of the colorimetric sensor 150 may be easily visually identified from the outside of the fitting locking portion 100. Through this, the colorimetric sensor 150 may be attached to any location of the fitting locking portion 100 and then used. Here, to make it more visible to workers, the colorimetric sensor 150 may be implemented to be attached to an internal space formed by the locking portions 141 and 142. FIG. 4 illustrates an example of the colorimetric sensor 150 attached to the internal space formed by the locking portions 141 and 142.

Meanwhile, as shown in FIGS. 1 and 3, uneven portions 111 and 121 configured to engage each of a plurality of edges formed in a corresponding fitting (e.g., fitting 420) may be formed inside at least one of the fitting support member 120 and the fitting cover member 110. FIGS. 1 and 2 illustrate only the uneven portion 121 formed inside the fitting support member 120, while the example embodiment illustrates the uneven portion 121 formed inside the fitting support member 120 and the uneven portion 111 formed inside the fitting cover member 110. Through the uneven portions 111 and 121, the fitting locking portion 100 may perfectly fix the fitting 420 of the pipe 410 to not be loose due to external force.

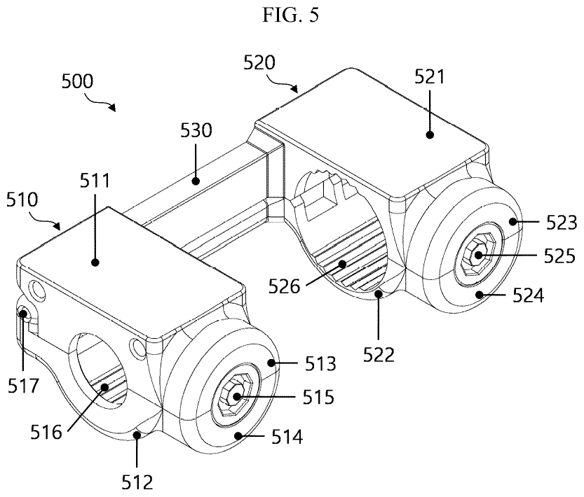

FIGS. 5 to 7 illustrate examples of a locking device for fitting according to another example embodiment. A locking device 500 for fitting according to the example embodiment may include a first fitting locking portion 510 configured to surround a first fitting that connects a valve 710 and a first pipe 720, a second fitting locking portion 520 configured to surround a second fitting that connects the valve 710 and a second pipe 730, and a locking portion connecting portion 530 configured to connect the first fitting locking portion 510 and the second fitting locking portion 520.

Here, each of the first fitting locking portion 510 and the second fitting locking portion 520 may correspond to the fitting locking portion 100 described above with reference to FIGS. 1 to 4, and may further include a structure for connection to the locking portion connecting portion 530. For example, the first fitting locking portion 510 and the second fitting locking portion 520 may, respectively, include fitting support members 512 and 522 each configured to surround a portion of a corresponding fitting, fitting cover member 511 and 521 each configured to surround a remainder of the fitting to correspond to the fitting support member 512, 522, connecting portions 517 and 527 each configured to rotatably connect one end of the fitting support member 512, 522 and one end of the fitting cover member 511, 521, and locking portions 513, 514, and 515, and 523, 524, and 525 each configured to secure another end of the fitting support member 512, 522 and another end of the fitting cover member 511, 521 to enable opening and closing.

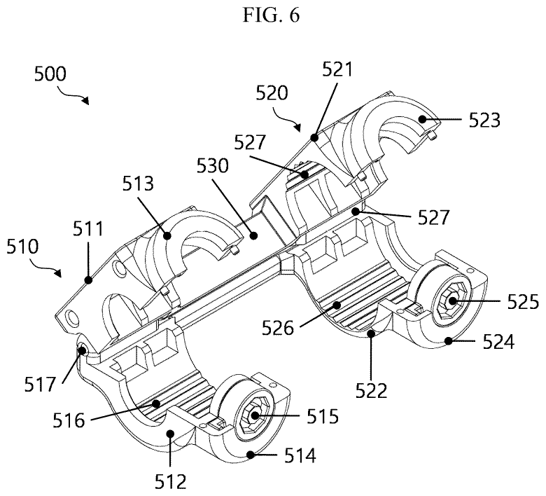

Meanwhile, as shown in FIGS. 5 and 6, uneven portions 516 and 526 configured to engage each of a plurality of edges formed in a corresponding fitting (e.g., the first fitting and the second fitting) may be formed inside at least one of the fitting support member 512 and the fitting cover member 511, and at least one of the fitting support member 522 and the fitting cover member 521.

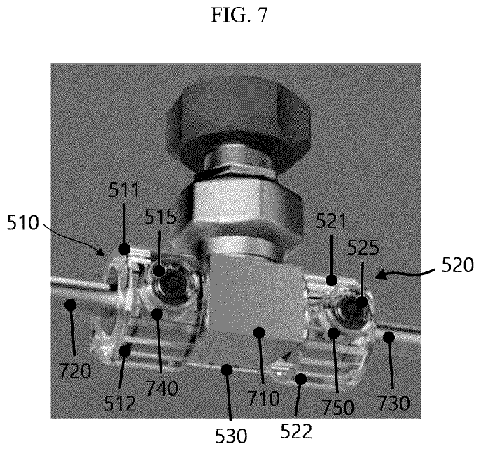

Here, colorimetric sensors 740 and 750 may be included in the first fitting locking portion 510 and the second fitting locking portion 520, respectively. Even in this case, to be more visible to workers, the colorimetric sensors 740 and 750 may be implemented to be attached to the internal space formed by the locking portions 513 and 514, and 523 and 524, respectively. FIG. 7 illustrates an example in which the first colorimetric sensor 740 is attached to the internal space formed by the first locking portions 513 and 514, and the second colorimetric sensor 750 is attached to the internal space formed by the second locking portions 523 and 524.

Meanwhile, a colorimetric sensor may be implemented to include a nanofiber membrane in a three-dimensional (3D) porous structure, bound with color dye of which color changes due to hazardous chemicals.

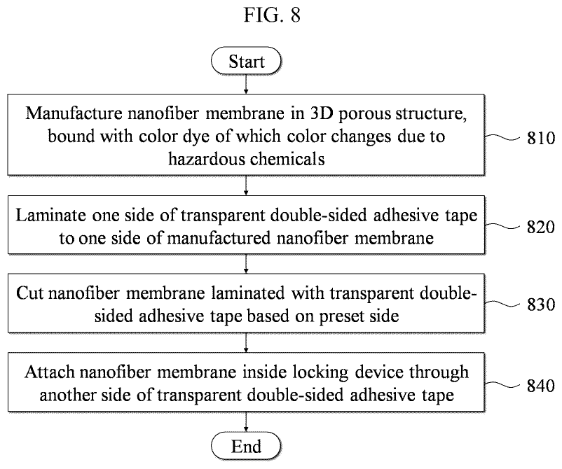

FIG. 8 is a flowchart illustrating an example of a method of manufacturing a colorimetric sensor for a locking device according to an example embodiment. The method of manufacturing the colorimetric sensor for the locking device according to the example embodiment may include operation 810 of manufacturing a nanofiber membrane in a 3D porous structure, bound with color dye of which color changes due to hazardous chemicals, operation 820 of laminating one side of a transparent double-sided adhesive tape to one side of the manufactured nanofiber membrane, operation 830 of cutting the nanofiber membrane laminated with the transparent double-sided adhesive tape based on a preset size, and operation 840 of attaching the nanofiber membrane inside the locking device through another side of the transparent double-sided adhesive tape.

In an example embodiment, the color dye may be mixed in a polymer solution and electrospun and bound to the nanofiber membrane that is manufactured through the electrospinning. For example, by preparing the polymer solution containing the color dye and by electrospinning the polymer solution onto release paper, the nanofiber membrane with the color dye bound may be manufactured. In another embodiment, the color dye may be bound on the manufactured nanofiber membrane through solution coating and chemical vapor deposition. For example, after initially manufacturing the nanofiber membrane by preparing the polymer solution and electrospinning the same on non-woven fabric, the color dye may be bound to the already-manufactured nanofiber membrane through dye coating or chemical vapor deposition.

Meanwhile, since a change in color of the nanofiber membrane to which the color dye is bound needs to be visually identifiable from the outside through both the double-sided adhesive tape and the locking device, not only the fitting locking portion 100, 510, 520 but also the double-sided adhesive tape needs to be implemented using a transparent material. Here, one side of the nanofiber membrane may be laminated to one side of the transparent double-sided adhesive tape. Here, one side of the nanofiber membrane laminated with the double-sided adhesive tape may be the side to which the release paper or the non-woven fabric is not coupled. After the nanofiber membrane is cut based on the preset size, the release paper or the non-woven fabric may be removed. The nanofiber membrane may be attached inside the locking device through the other side of the transparent double-sided adhesive tape and may function as the colorimetric sensor.

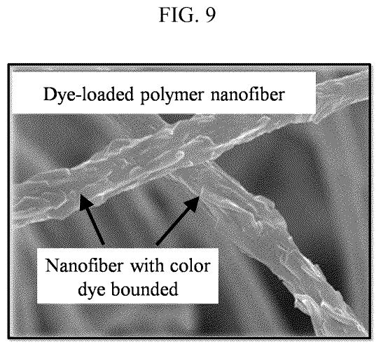

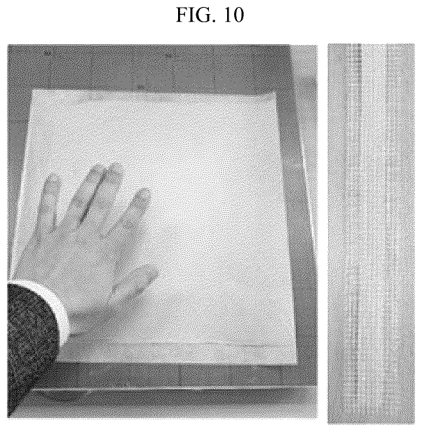

FIG. 9 is an image showing an example of nanofiber to which color dye is bound according to an example embodiment, and FIG. 10 is an image showing an example in which a nanofiber membrane to which color dye is bound is cut based on a preset size and laminated with a double-sized adhesive tape according to an example embodiment. FIG. 10 shows an example of using a double-sided adhesive tape in a mesh structure to detect a change in color of a colorimetric sensor instead of a transparent double-sided adhesive tape.

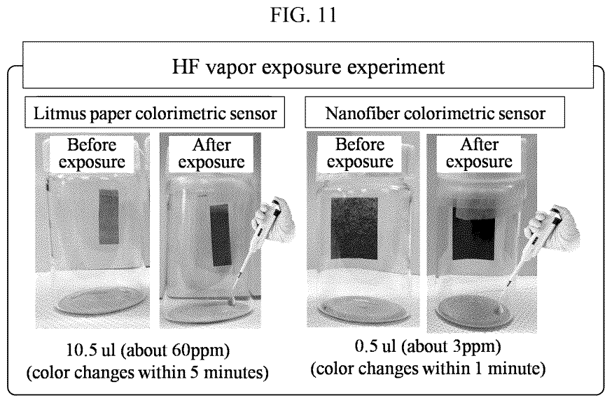

FIG. 11 illustrates results of hydrofluoric acid vapor exposure experiment of a litmus paper colorimetric sensor and a nanofiber-based colorimetric sensor according to an example embodiment. In the case of the litmus paper colorimetric sensor, a commercially available litmus paper product was used. Also, the nanofiber-based colorimetric sensor contained 9.5 wt % of Congo red dye in polyacrylonitrile polymer and was manufactured by coating nanofiber with the thickness of about 10 μm on polyethylene (PE) non-woven fabric through electrospinning. As shown in experimental results of FIG. 11, it can be seen that the nanofiber-based colorimetric sensor more quickly and more clearly shows color change when exposed to a smaller amount of hydrofluoric vapor than the litmus paper colorimetric sensor. That is, it can be seen that the nanofiber-based colorimetric sensor has better sensitivity than the litmus paper colorimetric sensor.

As described above, according to example embodiments, it is possible to prevent leakage of hazardous chemicals due to a loose connecting portion of a pipe or a valve and, at the same time, to quickly detect a leakage area.

While the example embodiments are described with reference to specific example embodiments and drawings, it will be apparent to one of ordinary skill in the art that various changes and modifications in form and details may be made in these example embodiments from the description. For example, suitable results may be achieved if the described techniques are performed in different order, and/or if components in a described system, architecture, device, or circuit are combined in a different manner, or replaced or supplemented by other components or their equivalents.

Therefore, other implementations, other example embodiments, and equivalents of the claims are to be construed as being included in the claims.

What is claimed is:

1. A locking device for fitting, comprising:
a fitting locking portion made of a transparent material and provided to surround a fitting of a pipe or a valve; and
a colorimetric sensor provided inside the fitting locking portion and of which color changes due to hazardous chemicals leaked from the fitting.

2. The locking device of claim 1, wherein the colorimetric sensor includes a nanofiber membrane in a three-dimensional (3D) porous structure, bound with color dye of which color changes due to hazardous chemicals.

3. The locking device of claim 2, wherein the color dye is mixed in a polymer solution and electrospun and bound to the nanofiber membrane that is manufactured through the electrospinning or bound on the nanofiber membrane through solution coating or chemical vapor deposition.

4. The locking device of claim 1, wherein the colorimetric sensor is attached to a transparent double-sided adhesive tape capable of supporting a nanofiber membrane included in the colorimetric sensor and fixedly attached inside the fitting locking portion through the transparent double-sided adhesive tape.

5. The locking device of claim 1, wherein the fitting locking portion includes:
a fitting support member configured to surround a portion of the fitting of the pipe;
a fitting cover member configured to surround a remainder of the fitting to correspond to the fitting support member;
a connecting portion configured to rotatably connect one end of the fitting support member and one end of the fitting cover member; and
a locking portion configured to secure another end of the fitting support member and another end of the fitting cover member to enable opening and closing.

6. The locking device of claim 1, wherein the fitting locking portion includes:
a first fitting locking portion configured to surround a first fitting that connects the valve and a first pipe;
a second fitting locking portion configured to surround a second fitting that connects the valve and a second pipe; and
a locking portion connecting portion configured to connect the first fitting locking portion and the second fitting locking portion.

7. The locking device of claim 6, wherein each of the first fitting locking portion and the second fitting locking portion includes:
a fitting support member configured to surround a portion of a corresponding fitting;
a fitting cover member configured to surround a remainder of the fitting to correspond to the fitting support member;
a connecting portion configured to rotatably connect one end of the fitting support member and one end of the fitting cover member; and
a locking portion configured to secure another end of the fitting support member and another end of the fitting cover member to enable opening and closing.

8. The locking device of claim 7, wherein the colorimetric sensor is provided inside the locking portion.

9. The locking device of claim 7, wherein an uneven portion configured to engage each of a plurality of edges formed in a corresponding fitting is formed inside at least one of the fitting support member and the fitting cover member.

10. A method of manufacturing a colorimetric sensor for a locking device, the method comprising:
manufacturing a nanofiber membrane in a three-dimensional (3D) porous structure, bound with color dye of which color changes due to hazardous chemicals;
laminating one side of a transparent double-sided adhesive tape to one side of the manufactured nanofiber membrane;
cutting the nanofiber membrane laminated with the transparent double-sided adhesive tape based on a preset side; and
attaching the nanofiber membrane inside the locking device through another side of the transparent double-sided adhesive tape.
